(19) United States
(12) Patent Application Publication
(10) Pub. No.: US 2025/0297652 A1
(43) Pub. Date: Sep. 25, 2025

(54) ACTUATOR ASSEMBLY FOR AN ELECTROMECHANICAL VEHICLE BRAKE

(71) Applicant: ZF Active Safety GmbH, Koblenz (DE)

(72) Inventor: Volker Knop, Ulmen (DE)

(73) Assignee: ZF Active Safety GmbH, Koblenz (DE)

(21) Appl. No.: 19/086,474

(22) Filed: Mar. 21, 2025

(30) Foreign Application Priority Data
Mar. 25, 2024 (DE) 102024108489.8

(51) Int. Cl. F16D 55/226; F16D 121/24; F16D 125/40

(52) U.S. Cl. CPC F16D 55/226; F16D 2121/24; F16D 2125/40

(57) ABSTRACT

An actuator assembly for an electromechanical vehicle brake is proposed, having a brake caliper in which an intermediate space for a brake rotor is formed, wherein a brake lining, which can be applied to the brake rotor, is arranged in the intermediate space, a spindle drive which has a spindle sleeve, a spindle nut and a drive shaft, driven by an electric motor, for adjusting the spindle nut in an axial direction via the spindle sleeve, wherein the spindle nut is movable between an extended and a retracted position by axial adjustment and the drive shaft is coupled to the spindle sleeve via a gear mechanism, and wherein the gear mechanism is arranged at least partially inside the spindle nut and/or the spindle sleeve in the axial direction.

### CROSS-REFERENCE TO RELATED APPLICATIONS

This application claims priority to German Patent Application No. 102024108489.8, filed Mar. 25, 2024, the disclosure of which is incorporated herein by reference in its entirety.

### TECHNICAL FIELD

The disclosure relates to an actuator assembly for an electromechanical vehicle brake.

### BACKGROUND

Actuator assemblies serve, in vehicle brakes, to apply a brake lining to a brake rotor. For this purpose, the actuator assembly usually has a spindle drive which has a spindle nut and a spindle, driven by an electric motor, for axially moving the spindle nut. An axial feed force for applying the brake lining to the brake rotor is transmitted from the spindle nut to the brake lining.

The electric motor, via which the spindle drive is driven, is arranged, in terms of its drive axis, eccentrically with respect to the drive axis of the spindle drive.

Therefore, in order to couple the electric motor to the spindle drive, a one-stage gear mechanism is provided between the electric motor and spindle and additionally a planetary gear mechanism is provided on the spindle, in order for it to be possible to provide a corresponding axial feed force for applying the brake lining.

However, the space conditions in the region of actuator assemblies for electromechanical vehicle brakes are generally very confined. Consequently, an area of application of actuator assemblies is always dependent on the space requirement thereof, wherein a relatively high space requirement of an actuator assembly is disadvantageous.

Therefore, what is needed is to provide an actuator assembly for an electromechanical vehicle brake, which has a particularly low space requirement.

### SUMMARY

An actuator assembly for an electromechanical vehicle brake is disclosed herein, having a brake caliper in which an intermediate space for a brake rotor is formed, wherein a brake lining, which can be applied to the brake rotor, is arranged in the intermediate space, a spindle drive which has a spindle sleeve, a spindle nut and a drive shaft, driven by an electric motor, for adjusting the spindle nut in an axial direction via the spindle sleeve. The spindle nut is movable between an extended and a retracted position by axial adjustment. The drive shaft is coupled to the spindle sleeve via a gear mechanism, and the gear mechanism is arranged at least partially inside the spindle nut and/or the spindle sleeve in the axial direction.

The basic concept of the disclosure is to reduce the installation length of the actuator assembly in that the space that is not used within the spindle nut and/or the spindle sleeve is used for the arrangement of the gear mechanism, which is required for driving the spindle drive via an electric motor, at least partially inside the spindle nut and/or the spindle sleeve. The spindle sleeve is located inside the spindle nut and drives the latter via the spindle drive, i.e., for example, the interposed balls.

Consequently, the space taken up by the actuator assembly is reduced and so space can be saved and, at the same time, the available space within the actuator assembly itself can be utilized more effectively.

The term “gear mechanism” is considered to cover only the gears or toothed portions by which the gear mechanism is formed, without taking into account, for example, the shafts or sleeves on which the gears or toothed portions are fitted. These can optionally be located partially or entirely outside the spindle nut and/or the spindle sleeve.

According to one aspect of the disclosure, the gear mechanism may be arranged entirely inside the spindle nut and/or the spindle sleeve in the axial direction.

This is a particularly effective arrangement in order to save the space taken up by the actuator assembly and at the same time to utilize the available space within the actuator assembly as effectively as possible.

Furthermore, the drive shaft may have a pinion, while the spindle sleeve has internal teeth.

In this case, the pinion of the drive shaft and the internal teeth of the spindle sleeve are part of the gear mechanism, and so use can be made at least partially of components that are already present anyway in the actuator assembly in order to provide components or subregions of the gear mechanism.

Furthermore, the spindle sleeve may have a cavity in which at least a part of the gear mechanism is accommodated, wherein the internal teeth extend only along a part of the total axial length of the cavity.

Since the internal teeth extend only along a part of the total axial length of the cavity, it is easier to manufacture the internal teeth.

Furthermore, the internal teeth may be embodied integrally with the spindle sleeve. This makes it easier to assemble the actuator assembly since it is not necessary to provide an additional component that has the internal toothing and has to be coupled to the spindle sleeve for conjoint rotation.

The gear mechanism may be a one-stage gear mechanism.

A one-stage gear mechanism makes it possible to implement a simple gear mechanism with few components but also makes it possible to provide an appropriate gear ratio between the electric motor and the spindle drive.

Furthermore, one-stage gear mechanisms can be embodied in a particularly robust manner.

The gear mechanism may be a planetary gear mechanism, wherein the internal teeth form a ring gear and the pinion forms a sun gear and planetary gears are provided in between, which engage with the teeth of the pinion and with the internal teeth of the spindle sleeve.

Consequently, the planetary gear mechanism, as already described above, consists for the most part of components of the actuator assembly that are already present, such that only the pinion needs to be provided on the drive shaft and the internal teeth need to be introduced into the spindle sleeve in the form of a ring gear.

Therefore, only the planetary gears are additionally necessary in order to form the planetary gear mechanism.

Alternatively, the gear mechanism may also be a multistage gear mechanism.

As a result, a larger transmission ratio can be realized between the electric motor or the drive shaft and the spindle nut or the spindle sleeve, respectively.

The gear mechanism may also be a Wolfrom gear mechanism, wherein the internal teeth form a ring gear and the pinion forms a sun gear, and a non-rotating ring-gear sleeve that is arranged coaxially with the drive shaft and has ring-gear teeth is additionally provided, as are planetary gears of a first stage and planetary gears, rotationally coupled thereto, of a second stage which have, in pairs, the same central axis as but a different pitch circle from the planetary gears of the first stage. The planetary gears of the first stage engage with the teeth of the pinion and ring-gear teeth of the ring-gear sleeve, and the planetary gears of the second stage engage with the internal teeth of the spindle sleeve. A Wolfrom gear mechanism is a planetary gear mechanism with a high transmission ratio, which has an extremely compact structure and is characterized by a minimal difference between the pitch circles of the two ring gears, by way of which the high transmission ratio is realized.

The ring-gear sleeve may, in this case, be coupled to the brake caliper for conjoint rotation. Furthermore, a planetary carrier may be provided, by which the planetary gears of the first and second stage are held.

The planetary carrier may include bars and end plates, wherein bores may be provided in the end plates, into which bores planetary axles are pressed in order to save costs.

The planetary gears are mounted on the planetary axles rotatably, for example by way of plain bearings, in order to save space and costs.

The Wolfrom gear mechanism is particularly suitable here since it requires little installation space and so can be arranged easily inside the spindle nut and/or the spindle sleeve. Moreover, it makes it possible to realized large transmission ratios.

In this case, the ring-gear sleeve may extend into the interior of the spindle nut and/or spindle sleeve. It also makes it possible for the actuator assembly to require particularly little space.

Furthermore, the drive shaft may be mounted in the ring-gear sleeve via a rolling bearing.

Consequently, the ring-gear sleeve assumes multiple functions at once, since it has the ring-gear teeth for the first stage of the planetary gears and, at the same time, accommodates and supports the drive shaft.

Furthermore, a planetary carrier may be provided, which is mounted in the spindle sleeve on one side and in the ring-gear sleeve on the other side.

Furthermore, the drive shaft may be coupled without a gear mechanism to a motor shaft of an electric motor, or be coupled to a motor shaft of an electric motor via a gear-mechanism unit, for example, a one-stage gear-mechanism unit, arranged entirely outside the spindle nut and/or spindle sleeve.

Accordingly, an additional gear mechanism is not necessary, with the result that the production costs and the complexity of the actuator assembly are reduced.

Alternatively, only a one-stage gear mechanism is required, which can be provided particularly easily and cost-effectively.

### BRIEF DESCRIPTION OF THE DRAWINGS

The disclosure is described in the following text by way of an exemplary arrangement which is illustrated in the appended drawings, in which:

FIG. 1 shows a sectional view of an actuator assembly according to the disclosure;

FIG. 2 shows a half-section of a part of the spindle drive with a Wolfrom gear mechanism of the actuator assembly according to the disclosure in a perspective view;

FIG. 3 shows the part of the spindle drive with the Wolfrom gear mechanism from FIG. 2 in an exploded illustration;

FIG. 4 shows a schematic illustration of a rear side of the actuator assembly according to the disclosure, which can be seen in FIG. 3; and

FIG. 5 shows the illustration from FIG. 3 without a Wolfrom gear mechanism.

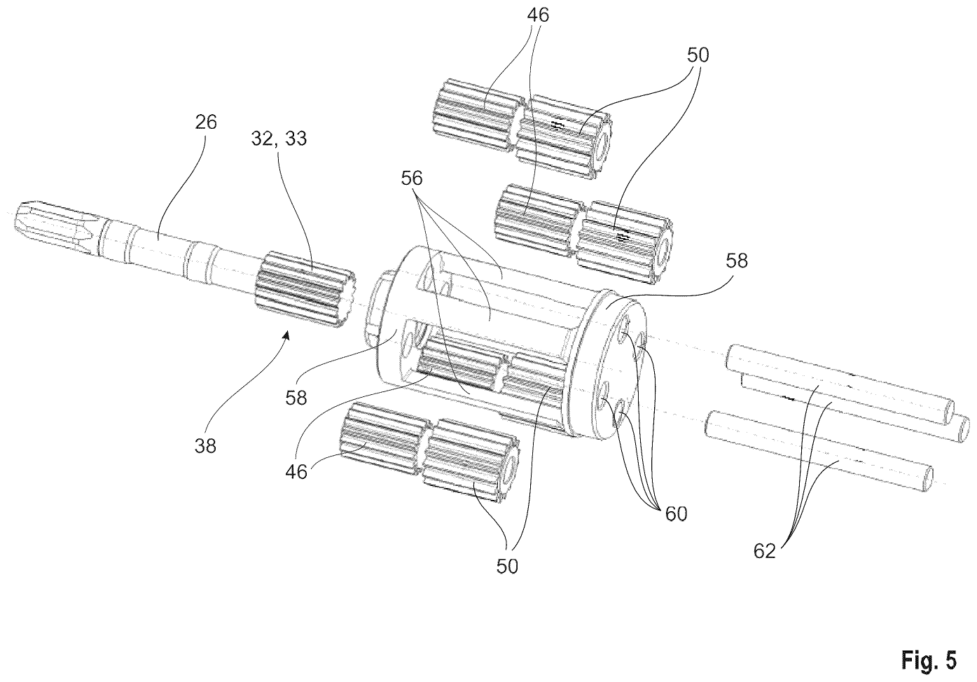

### DETAILED DESCRIPTION

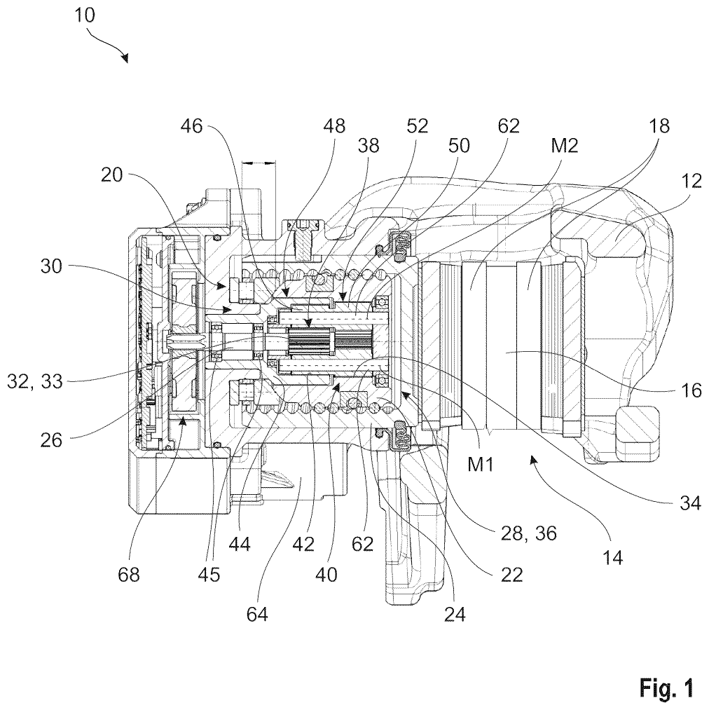

FIG. 1 shows an actuator assembly 10 for an electromechanical vehicle brake.

The actuator assembly 10 comprises a brake caliper 12, in which an intermediate space 14 for a brake rotor 16 is formed.

Arranged in the intermediate space 14, on each side of the brake rotor 16, is at least one brake lining 18, which can be applied to the brake rotor 16.

Furthermore, the actuator assembly 10 comprises a spindle drive 20, which is a ball screw drive in the exemplary arrangement, with a rotatably mounted spindle sleeve 22 which is driven by an electric motor and on the outer shell of which a spindle nut 24 for applying the brake lining 18 to the brake rotor 16 is mounted.

Also provided is a drive shaft 26, which serves to drive the spindle sleeve 22, wherein, via the spindle sleeve 22, the spindle nut 24 can in turn be axially adjusted.

In this case, the spindle nut 24 is adjusted by axial displacement between an extended position and a retracted position and guided linearly in the brake caliper 12. The spindle sleeve 22 and spindle nut are coupled together via a ball recirculation system such that, upon rotation of the spindle sleeve 22, the non-rotatable spindle nut 24 is axially adjusted.

The spindle nut 24 of the spindle drive 20 represents, for example, a brake piston.

The drive shaft 26 is coupled to the spindle sleeve 22 via a gear mechanism 28.

The spindle sleeve 22 has a cavity 30, inside which the gear mechanism 28 is accommodated such that it is arranged at least partially inside the spindle nut 24 and the spindle sleeve 22 in the axial direction.

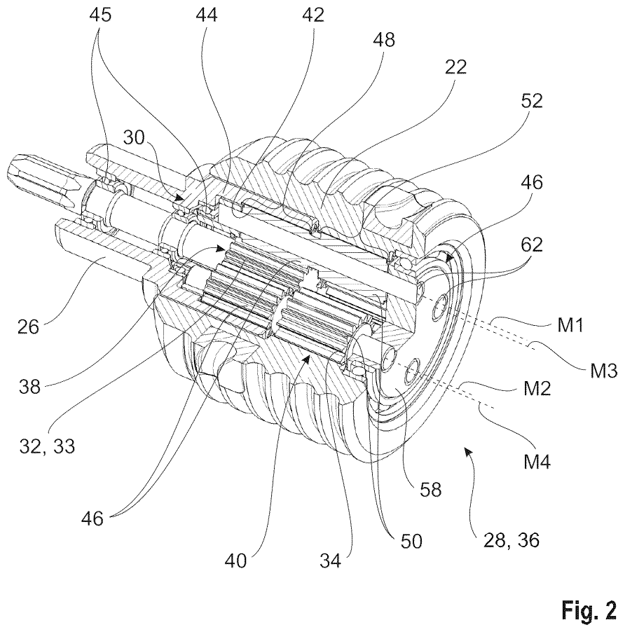

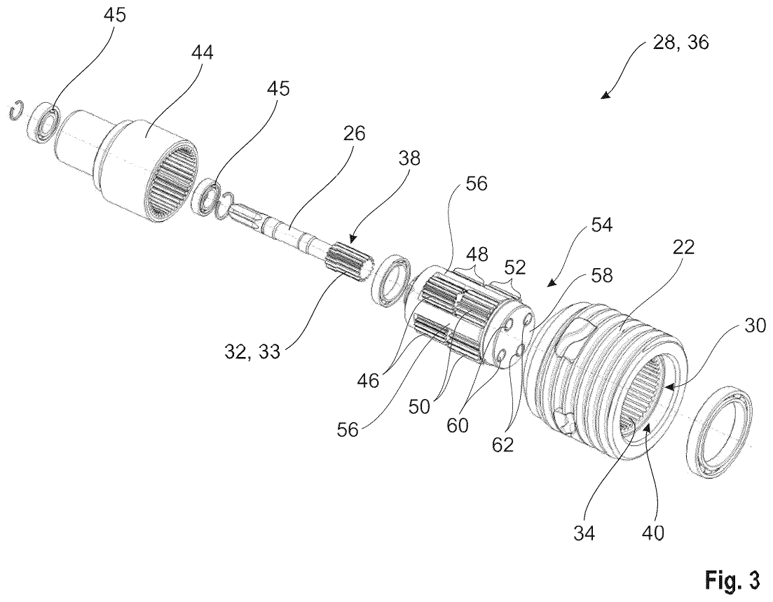

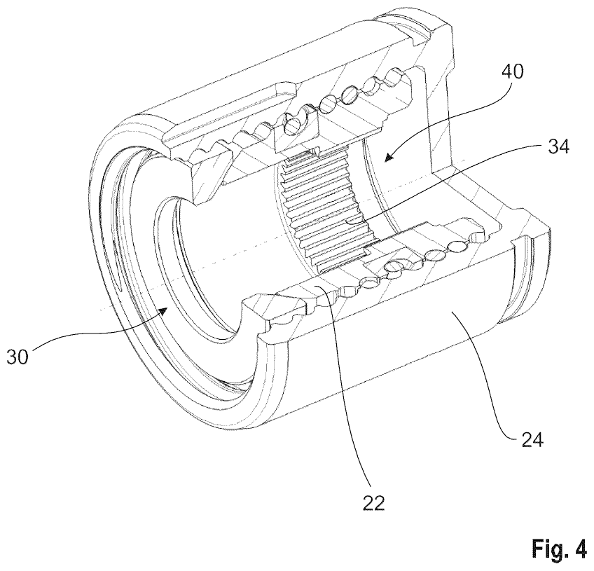

According to FIGS. 1 to 4, the gear mechanism 28 can, in this case, be arranged entirely inside the spindle sleeve 22.

Furthermore, it may additionally also be arranged entirely inside the spindle nut 24.

Alternatively, it is also conceivable for the gear mechanism 28 to be arranged only partially inside the spindle nut 24 and/or the spindle sleeve 22 in the axial direction.

The gear mechanism 28 comprises a pinion 32 having teeth 33. The pinion 32 is provided on the drive shaft 26.

In addition, the gear mechanism 28 comprises internal teeth 34, which are formed on the inner side of the spindle sleeve 22.

The internal teeth 34 extend in this case only along a part of the entire axial length of the cavity 30 of the spindle sleeve 22.

Consequently, only the gears or toothed portions are considered to be the gear mechanism, without the shafts and sleeves, on which the gears and toothed portions, respectively, are provided being taken into consideration.

The internal teeth 34 are in this case formed integrally with the spindle sleeve 22.

According to a first option, the gear mechanism 28 is a multi-stage planetary gear mechanism in the form of a Wolfrom gear mechanism 36.

In this Wolfrom gear mechanism 36, the pinion 32 is arranged coaxially with the spindle nut 24 and spindle sleeve 22, such that, as a result, a sun gear 38 is formed by the pinion 32.

The internal teeth 34 on the spindle sleeve 22 are in turn arranged coaxially with the pinion 32 and form a ring gear 40.

Furthermore, ring-gear teeth 42 are part of the gear mechanism 28 embodied as a Wolfrom gear mechanism 36, which is provided on a ring-gear sleeve 44.

The ring-gear sleeve 44 extends into the interior of the spindle sleeve 22. Consequently, the ring-gear sleeve 44 has a region which axially overlaps the cavity 30.

The drive shaft 26 is mounted via rolling bearings 45 within the ring-gear sleeve 44.

The ring-gear sleeve 44 is coupled to the brake caliper 12 for conjoint rotation.

Moreover, the gear mechanism 28 comprises a planetary carrier 46 of a first stage 48 and planetary gears 50, rotationally coupled thereto, of a second stage 52.

The planetary gears 46, 50 each have, in pairs, the same central axis M1 to M4.

The pitch circle of the planetary gears 46 of the first stage 48, on the outer side of which pitch circle the latter roll, differs minimally from the pitch circle of the planetary gears 50 of the second stage 52, however.

In this case, the pitch circle of the planetary gears 46 is in each case smaller than that of the planetary gears 50.

For mounting the planetary gears 46, 50, a planetary carrier 54 having bars 56 and end plates 58 is provided.

In the end plates 58, there are bores 60, into which, in turn, planetary axles 62 have been pressed.

Rotatably mounted in each case in pairs on each of the planetary axles 62 are a planetary gear 46 together with a planetary gear 50.

The planetary carrier 54 is in turn mounted in the spindle sleeve 22 on one side and in the ring-gear sleeve 44 on the other side.

The planetary gears 46 of the first stage 48 engage with the teeth 33 of the pinion 32 and with the internal teeth 34. The planetary gears 50 of the second stage 52 engage with the ring-gear teeth 42 of the ring-gear sleeve 44.

If the spindle nut is now intended to be adjusted in the axial direction, the drive shaft 26 is set in rotation.

As a result, the pinion 32 rotates, with the result that the planetary gears 46 of the first stage 48 are driven, wherein these mesh with the ring-gear teeth 42 of the conjointly rotating ring-gear sleeve 44.

Since each of the planetary gears 46 of the first stage 48 is coupled to in each case one planetary gear 50 of the second stage 52 for conjoint rotation, planetary gears 50 likewise carry out a rotational movement.

In this case, they engage with the internal teeth 34 such that there is a force flow between the drive shaft 26 and the spindle sleeve 22.

The spindle sleeve 22 consequently carries out a rotational movement, which is associated with a linear adjustment of the spindle nut 24.

According to a second option, the gear mechanism 28 may be configured as a one-stage gear mechanism (not shown in the figures).

In this case, the gear mechanism is a planetary gear mechanism, in which the internal teeth 34 on the spindle sleeve 22 likewise form a ring gear and the pinion 32 forms the sun gear of the planetary gear mechanism.

Provided between the ring gear formed by the internal teeth 34 and the pinion 32 that acts as a sun gear are planetary gears, which engage with the teeth of the pinion and the internal teeth of the spindle sleeve.

In both of the outlined options, the actuator assembly 10 additionally comprises an electric motor 64 with a motor shaft.

The electric motor 64 serves to move the spindle nut 24 between the retracted position and the extended position.

The motor shaft is coupled to the drive shaft 26 via a one-stage gear-mechanism unit 68, wherein the one-stage gear-mechanism unit 68 is arranged entirely outside the spindle sleeve 22.

Alternatively, it is conceivable for the drive shaft 26 to be coupled without a gear mechanism to the motor shaft of the electric motor 64, such that the motor shaft is arranged coaxially with the drive shaft 26.

1. An actuator assembly for an electromechanical vehicle brake, comprising:
a brake caliper in which an intermediate space for a brake rotor is formed, wherein a brake lining, which can be applied to the brake rotor, is arranged in the intermediate space,
a spindle drive which has a spindle sleeve, a spindle nut and a drive shaft driven by an electric motor, for adjusting the spindle nut in an axial direction via the spindle sleeve, wherein the spindle nut is movable between an extended and a retracted position by axial adjustment,
wherein the drive shaft is coupled to the spindle sleeve via a gear mechanism, and
wherein the gear mechanism is arranged at least partially inside the spindle nut and/or the spindle sleeve in the axial direction.

2. The actuator assembly according to claim 1, wherein the gear mechanism is arranged entirely inside the spindle nut and/or the spindle sleeve in the axial direction.

3. The actuator assembly according to claim 1, wherein the drive shaft has a pinion and the spindle sleeve has internal teeth.

4. The actuator assembly according to claim 3, wherein the spindle sleeve has a cavity in which at least a part of the gear mechanism is accommodated, and in that the internal teeth extend only along a part of a total axial length of the cavity.

5. The actuator assembly according to claim 3, wherein the internal teeth are embodied integrally with the spindle sleeve.

6. The actuator assembly according to claim 1, wherein the gear mechanism is a one-stage gear mechanism.

7. The actuator assembly according to claim 3, wherein the gear mechanism is a planetary gear mechanism, wherein the internal teeth form a ring gear and the pinion forms a sun gear and planetary gears are provided in between, which engage with teeth of the pinion and with the internal teeth of the spindle sleeve.

8. The actuator assembly according to claim 1, wherein the gear mechanism is a multistage gear mechanism.

9. The actuator assembly according to claim 3, wherein the gear mechanism is a Wolfrom gear mechanism, wherein the internal teeth form a ring gear and the pinion forms a sun gear, and a non-rotating ring-gear sleeve that is arranged coaxially with the drive shaft and has ring-gear teeth and planetary gears of a first stage and planetary gears, rotationally coupled thereto, of a second stage which have, in pairs, the same central axis as but a different pitch circle from the planetary gears of the first stage, wherein the planetary gears of the first stage engage with teeth of the pinion and the ring-gear teeth of the ring-gear sleeve, and the planetary gears of the second stage engage with the internal teeth of the spindle sleeve.

10. The actuator assembly according to claim 9, wherein the ring-gear sleeve extends into an interior of the spindle sleeve.

11. The actuator assembly according to claim 9, wherein the drive shaft is mounted in the ring-gear sleeve via a rolling bearing.

12. The actuator assembly according to claim 9, wherein a planetary carrier is provided, which is mounted in the spindle sleeve on one side and in the ring-gear sleeve on the other side.

13. The actuator assembly according to claim 1, wherein the drive shaft is coupled without a gear mechanism to a motor shaft of an electric motor, or in that the drive shaft is coupled to a motor shaft of an electric motor via a gear-mechanism unit arranged entirely outside the spindle sleeve.

14. The actuator assembly according to claim 2, wherein the drive shaft has a pinion and the spindle sleeve has internal teeth.

15. The actuator assembly according to claim 4, wherein the internal teeth are embodied integrally with the spindle sleeve.

16. The actuator assembly according to claim 15, wherein the gear mechanism is a one-stage gear mechanism.

17. The actuator assembly according to claim 16, wherein the gear mechanism is a planetary gear mechanism, wherein the internal teeth form a ring gear and the pinion forms a sun gear and planetary gears are provided in between, which engage with teeth of the pinion and with the internal teeth of the spindle sleeve.

18. The actuator assembly according to claim 17, wherein the gear mechanism is a Wolfrom gear mechanism, wherein the internal teeth form a ring gear and the pinion forms a sun gear, and a non-rotating ring-gear sleeve that is arranged coaxially with the drive shaft and has ring-gear teeth and planetary gears of a first stage and planetary gears, rotationally coupled thereto, of a second stage which have, in pairs, the same central axis as but a different pitch circle from the planetary gears of the first stage, wherein the planetary gears of the first stage engage with teeth of the pinion and the ring-gear teeth of the ring-gear sleeve, and the planetary gears of the second stage engage with the internal teeth of the spindle sleeve.

19. The actuator assembly according to claim 10, wherein the drive shaft is mounted in the ring-gear sleeve via a rolling bearing.

20. The actuator assembly according to claim 19, wherein a planetary carrier is provided, which is mounted in the spindle sleeve on one side and in the ring-gear sleeve on the other side.
